(19) United States
(12) Patent Application Publication
(10) Pub. No.: US 2015/0201464 A1
(43) Pub. Date: Jul. 16, 2015

(54) ELECTRICAL HEATING ELEMENT

(71) Applicant: QUANTUM TECHNOLOGY GROUP (SINGAPORE) PTE LTD., Singapore (SG)

(72) Inventor: Ki CHAN, Hong Kong (CN)

(21) Appl. No.: 14/630,543

(22) Filed: Feb. 24, 2015

Related U.S. Application Data
(63) Continuation of application No. PCT/EP2012/066909, filed on Aug. 30, 2012.

(51) Int. Cl. H05B 3/42; H05B 3/00

(52) U.S. Cl. CPC H05B 3/42; H05B 3/0095

(57) ABSTRACT

An electrical heating element 1 comprising at least a heater body 30 enclosing a compartment 50 having an inner surface 31 and at least one heater cartridge 10 which is inserted into the compartment 50 provides a particular uniform heat distribution if the compartment 50 is evacuated and its inner surface 31 is coated with at least one inorganic salt.

### CROSS-REFERENCE TO RELATED APPLICATION

This application is a continuation of pending International Application No. PCT/EP2012/066909 filed on 30 Aug. 2012, which designates the United States.

### BACKGROUND OF THE INVENTION

1. Field of the Invention

The invention relates to the field of electrical heating, in particular in industrial applications. The electrical heating element comprises a heater cartridge being arranged inside a compartment of a heater body.

2. Description of Relevant Art

U.S. Pat. No. 7,335,857B2 discloses a rod shaped electrical heating element being composed of an electrical conductive ceramic material. A cylindrical heat carrier ring with an electrically insulating outer surface is positioned using magnetic deforming on the rod shaped electrical heating element. The rod shaped electrical heating element and the cylindrical heat carrier are positioned in a rod shaped casing. Such electrical heaters are used as glow plug for example in industrial and automotive applications in particular in diesel engines. A uniform heat distribution is not necessary as a local heat source is sufficient to initiate ignition of the air-diesel mixture.

WO 2012/016399A1 discloses a rod like electrical heater cartridge. The electrical heater cartridge has a rod like metal housing. In the housing is a heating wire. The remaining space of the housing is filled with a thermally conductive but electrically insulating material made of magnesia powder and silicone oil to thereby obtain a uniform heat distribution.

EP 1 855 066 discloses an electrical heater comprising a ladder like hollow structure made of metal tubes which are fluid communication and filled with an liquid heat carrier. An electrical heater cartridge is inserted in the lower end of one of the two vertical beams. A motor driven pump is located in the opposite vertical beam for circulating the liquid in the hollow structure and to thereby obtain a uniform heat distribution.

### SUMMARY OF THE INVENTION

The problem to be solved by the invention is to provide a simple, reliable and flexible electrical heater.

In an embodiment and electrical heating element comprises at least a heater body enclosing a compartment having an inner surface and at least one heater cartridge being inserted into the compartment. Preferably the compartment is evacuated for example to about 105 Pa or lower and its inner surface may advantageously be coated with at least one inorganic salt. The coating can be for example the coating as described in detail in the PCT-application PCT/EP2012/066894 to Mr. Ki Chan, which is incorporated by reference as if fully disclosed herein. The heater cartridge typically comprises an electricity to heat conversion element as heat source.

The electrical heating element can be used instead of a conventional constructional element in engineering for applying heat to some heat sink, for example roller dryer or the like. However, the electrical heating element permits to obtain an extremely homogenous heat distribution at a very low weight and with a very low effort, as no convection takes place inside the compartment as it is the case for usual heat pipe technologies. In addition the invention distinguishes over the heat pipe technologies as the form of the compartment not necessarily requires to have the form of a pipe, however it may have. The heat transfer mechanism is theoretically not yet fully understood, however proved to be extremely efficient. First experimental data suggest that the heat transfer is enhance by phonon excitations, which in uncoated metals play only a minor role in heat conduction, what becomes apparent when comparing the heat conductivity of electrical conductors and isolators (c.f. Solid State Physics, Ashcroft Mermin, Saunders Coll. Publ., 1976, Chap. 1 and Chap. 25).)

The heater body may have any form, but particularly suited is the form of a rod. The heater cartridge may for example comprise any material to which Ohm's law applies, i.e. which produces heat when applying a current to it. Thus it is sufficient to apply a current to the material to activate the heat source. Such heater cartridges are commonly available, often in form of rods or bars.

For example, the heater body may be a rod like hollow profile having a first and a second narrow facing side, being closed by end caps. Such heater bodies can be manufactured very easily from commonly available metal parts. Alter-natively other materials like in particular glass or quartz bodies, e.g. tubes may be used. In addition, the inner surface of the hollow profile can be easily thoroughly cleaned, in particular degreased. As well dust and oxides should be removed from at least the inner surface of the compartment. The compartment can subsequently be closed by end caps, which preferably as well have been cleaned.

The at least one heater cartridge can be for example an electrical heating rod, as commercially available. The heater cartridge may be supported by at least one of the end caps such that there remains a space between the heater cartridge and the inner surface of the profile. For example, the heater cartridge may have an outer surface shell, being spaced from the inner surface of the compartment. In case of a heater body being made of a hollow profile its inner diameter may be bigger than an outer diameter of the, e.g., rod shaped heater cartridge.

Preferably, the heater cartridge is coaxially aligned to and inside the rod like hollow profile. This ensures a particular even heat distribution over the surface of the body.

The heater body preferably has a channel for evacuating the compartment and/or for coating the inner surface of the heater body with at least one inorganic salt. The coating can be applied as described in the application PCT/EP2012/066894. Alternatively other coating techniques like vapor deposition techniques can be used.

The channel may be permanently closed after evacuating the compartment. Inside the compartment is preferably a pressure of 105 Pa or lower.

Manufacturing of the electrical heater element is extremely simple. For example one may start with a hollow profile as electrical heater body, and clean the inner surface thoroughly. The hollow profile may be made of a metal like aluminum, stainless steel (e.g. material number 1.4301/composition: X5CrNi18-10 or material number 1.4404/composition X2CrNiMo17-12-2) or carbon steel and at least its inner surface should be cleaned from dust, oxides oil and the like. Subsequently the profile is be closed by endcaps. One of the endcaps preferably supports an heater cartridge, which is thus inserted into the compartment of the profile when attaching the respective end cap. The other end cap may have a through hole as channel for evacuating the compartment and/or for inserting an aqueous solution, for example the one disclosed in the above cited patent application to Mr. Chan. Next the compartment is evacuated via the channel to preferably 105 Pa by connecting a vacuum pump to the channel. Subsequently an amount of the aqueous solution is filled into the compartment. The volume of the injected liquid should be between 1000 ml and 500 ml per m2 of the surface of the inner space. The surface is thus the inner surface 31 (c.f. FIG. 1) plus the surfaces of the heater cartridge and that part of the end cap's 20, 40 surface that bound the compartment. For example using a tubular profile having a diameter of 44 mm and length of 2 m, one should add about 150 ml of the coating liquid. This is about 5% (3 to 8%) of the volume of the inner space. To this end one preferably connects a branch of three way valve to the channel, connects the second branch to a vacuum pump and the third branch to an injector with the aqueous solution. When brining the injector and the evacuated compartment into fluid communication the predefined volume of the aqueous solution is sucked by the vacuum into to compartment. The channel may now be permanently sealed. Before sealing one may preferably connect the vacuum pump again to ensure that the pressure inside the compartment is preferably at least approximately 105 Pa or lower. When first applying a current to the heater cartridge the inner surface is coated and heat conduction of the electrical heater element is enhanced.

### BRIEF DESCRIPTION OF THE DRAWINGS

In the following, the invention will be described by way of example, without limitation of the general inventive concept, on examples of embodiment and with reference to the drawings.

FIG. 1 shows an example for an electrical heater element.

FIG. 2 shows a cross section of the electrical heater element along plane A-A as indicated in FIG. 1.

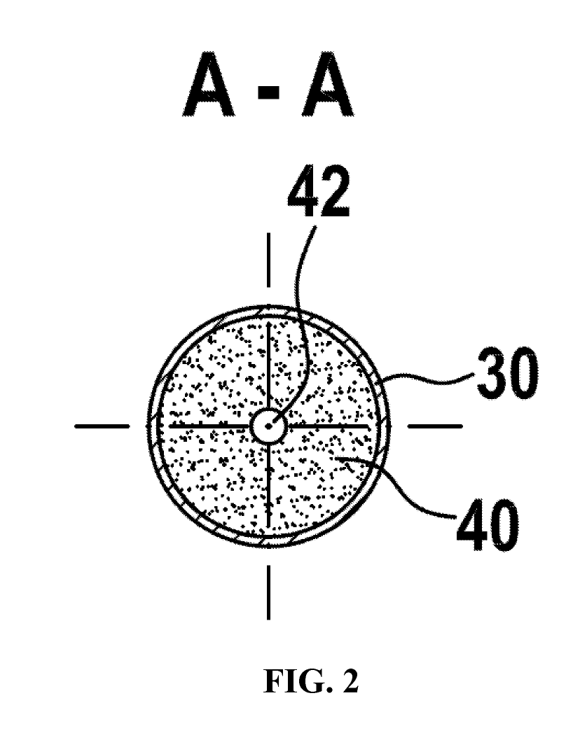

FIG. 3 shows a cross section of the electrical heater element along plane B-B as indicated in FIG. 1.

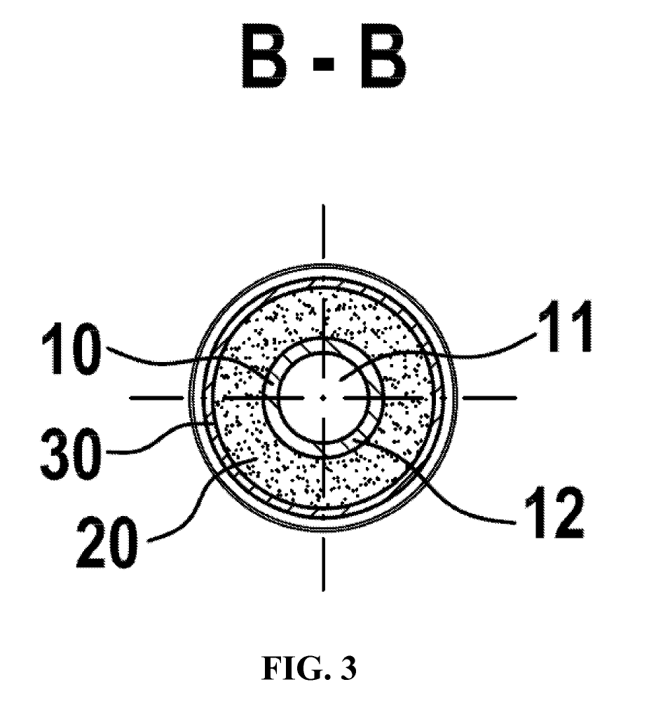

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

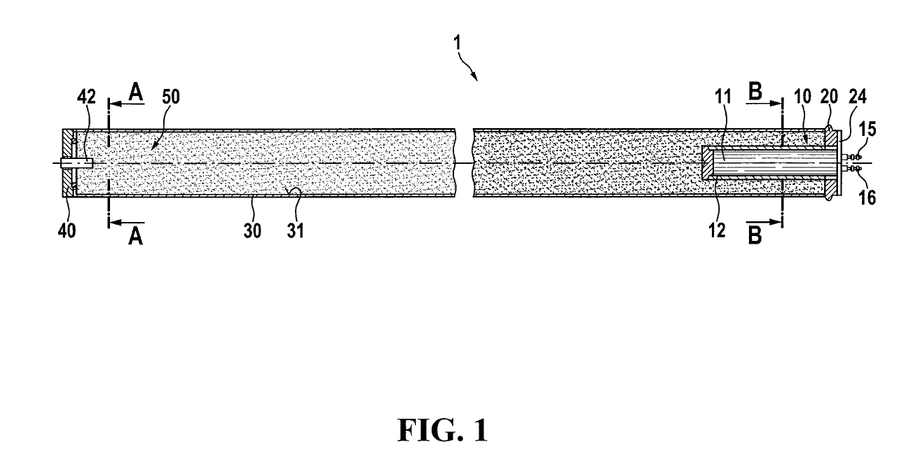

In FIG. 1 a preferred embodiment of an electrical heater element 1 is shown. The electrical heater element 1 has a hollow profile as heater body 30. The narrow sides of the heater body 30 are closed by end caps 20, 40. One end cap 20 has a sup-port plate 24 for supporting a rod like heater cartridge 10 being inserted coaxially into the compartment 50 of the heater body 30. Outside the compartment 50 are connector pins 15, 16 for connecting the heater cartridge 10 to a power supply, e.g. a power line. The heater cartridge 10 has a heater core 11 of a material following Ohm's law as heat source and a housing 12. In other words, the heater core 11 comprises an electricity to heat conversion element. Any other heater cartridge 10 may as well be used instead or additionally.

Opposed to end cap 20 is the end cap 40 having a channel 42 via which the compartment 50 can be connected with a vacuum pump and/or an injector for injecting an aqueous solution as explained above for example via a three way valve, which permits to first evacuate the compartment and subsequently to inject a predefined amount of an aqueous liquid. After insertion of the liquid and optional additional evacuation may the channel be sealed, for example by welding or bonding. The coating can as well be applied using other coating techniques, like vapor deposition.

It will be appreciated to those skilled in the art having the benefit of this disclosure that this invention is believed to provide an electrical heating element. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 electrical heating element
10 heater cartridge
11 electrical heating core
12 housing (rod like)
15 connector pin
16 connector pin
20 end cap
24 support plate
30 heater body
31 inner surface
40 end cap
42 channel/inlet
50 compartment

1. Electrical heating element comprising at least,
a heater body enclosing a compartment having an inner surface,
at least one heater cartridge, being inserted into the compartment,
wherein the compartment (50) is evacuated and its inner surface is coated with at least one inorganic salt.

2. Electrical heating element of claim wherein the heater body is a rod like hollow profile having a first and a second narrow facing side, being closed by end caps.

3. Electrical heating element of claim 2, wherein the at least one heater cartridge is an electrical heating rod, being supported by at least one of the end caps.

4. Electrical heating element of claim 2, wherein the heater cartridge is positioned coaxially in the rod like hollow profile.

5. Electrical heating element of one of claim 1, wherein the heater cartridge has an outer surface shell, being spaced from the inner surface of the compartment.

6. Electrical heating element of claim 1, wherein the rod like hollow profile has inner diameter being bigger than an outer diameter of the heater cartridge.

7. Electrical heating element of one of claim 1, wherein the heater body has a channel for evacuating the compartment and/or for inserting an aqueous solution of at least one inorganic salt.

8. Electrical heating element of claim 7, wherein said channel was permanently closed after evacuating the compartment.

9. Electrical heating element claim 1, wherein inside the compartment (50) is a pressure of 105 Pa or lower.
